(19) United States
(12) Patent Application Publication
(10) Pub. No.: US 2013/0054134 A1
(43) Pub. Date: Feb. 28, 2013

(54) TELEMATICS APPARATUS FOR DRIVING ASSISTANCE, SYSTEM OF THE SAME, AND METHOD OF THE SAME

(71) Applicants: Chih-Hsiang Wang, Taichung City (TW); Jin-Chin Chung, New Taipei City (TW); Shih-Tsun Chu, Kaohsiung City (TW); Yuan-Yi Chang, Douliu City (TW); Chun-Lung Huang, Taichung City (TW); Chih-Chung Kuo, Hsinchu City (TW)

(72) Inventors: Chih-Hsiang Wang, Taichung City (TW); Jin-Chin Chung, New Taipei City (TW); Shih-Tsun Chu, Kaohsiung City (TW); Yuan-Yi Chang, Douliu City (TW); Chun-Lung Huang, Taichung City (TW); Chih-Chung Kuo, Hsinchu City (TW)

(73) Assignee: INDUSTRIAL TECHNOLOGY RESEARCH INSTITUTE, HSINCHU (TW)

(21) Appl. No.: 13/354,799

(22) Filed: Jan. 20, 2012

(30) Foreign Application Priority Data
Aug. 23, 2011 (TW) 100130178

(51) Int. Cl. G01C 21/34

(52) U.S. Cl. 701/424; 701/408

(57) ABSTRACT

A telematics apparatus for providing driving assistance, and a system and a method are provided. The telematics apparatus receives position information indicating a current position of the telematics apparatus. The telematics apparatus transmits a request signal to the server. According to the request signal, the server obtains the position information, time information indicating a current time of the telematics apparatus, and identification information identifying a user of the telematics apparatus. The telematics apparatus displays driving assistance information received from the server which generates the driving assistance information according to the identification information, the position information, and the time information by searching through a route usage history of a plurality of routes and referring to a plurality of reference values of the routes. The reference value of each route indicates the telematics apparatus user's familiarity with that route.

This application claims the benefit of Taiwan application Serial No. 100130178, filed Aug. 23, 2011, the disclosure of which is incorporated by reference herein in its entirety.

### BACKGROUND

1. Technical Field

The disclosed embodiments relate in general to a telematics apparatus for providing driving assistance, and a system and a method of the same, and more particularly to a telematics apparatus for providing personalized driving assistance information, and a system and a method of the same.

2. Description of the Related Art

The driving assistance information, such as navigation information, provided by the telematics apparatus is important information indispensible to the driver. In order to provide necessary information for driving assistance, the telematics apparatus can receive position information related to its current position from a global positioning system (GPS). After a user, such as a driver, of the telematics apparatus inputs a destination, the telematics apparatus will plan a route and provide navigation information according to the current position of the telematics apparatus and the destination inputted by the user.

However, under some circumstances, the navigation information would become quite a nuisance to the user instead. For example, when the user is used to take certain route to his/her office from home, and has unwittingly developed a habit over the time. Therefore, even in the lack of the navigation information provided by the telematics apparatus, the user still knows the route very well. Meanwhile, if the telematics apparatus still keeps providing the user with navigation information as usual, the illustrated audio/video messages would turn into visual or auditory nuisance to the user.

### SUMMARY

The disclosure is directed to a telematics apparatus for providing personalized driving assistance information and a system and a method of the same which satisfy different users' various needs and expectations.

According to one embodiment, a method for providing driving assistance information is provided. The method includes several steps. The telematics apparatus receives position information indicating a current position of the telematics apparatus. The telematics apparatus transmits a request signal to a server. According to the request signal, the server obtains the position information, time information indicating a current time of the telematics apparatus, and identification information identifying a user of the telematics apparatus. The telematics apparatus receives driving assistance information from the server which generates the driving assistance information according to the identification information, the position information, and the time information by searching through a route usage history of a plurality of routes and referring to a plurality of reference values of the routes. The reference value of each route indicates the telematics apparatus user's familiarity with that route. The telematics apparatus displays the driving assistance information.

According to another embodiment, a system for providing driving assistance is provided. The system includes a telematics apparatus and a server. The telematics apparatus transmits a request signal. The server includes a database and a processing unit. The database stores a route usage history of a plurality of routes. For each route, the route usage history has a reference value indicating a user's familiarity with that route. According to the request signal, the processing unit obtains identification information identifying a user of the telematics apparatus, position information indicating a current position of the telematics apparatus, and time information indicating a current time of the telematics apparatus. The processing unit generates driving assistance information by searching through the route usage history according to the identification information, the position information, and the time information and referring to the reference values of the routes according to the search result, and further transmits the driving assistance information to the telematics apparatus.

According to an alternative embodiment, a telematics apparatus is provided. The telematics apparatus includes a positioning unit, a database, a processing unit, an output interface. The positioning unit captures position information indicating a current position of the telematics apparatus. The route database stores a route usage history of a plurality of routes. For each route, the route usage history has a reference value indicating a user's familiarity with that route. The processing unit obtains the position information, identification information identifying the telematics apparatus user, and time information indicating a current time of the telematics apparatus. The processing unit further generates driving assistance information by searching through the route usage history according to the identification information, the position information, and the time information and referring to the reference values of the routes according to the search result. The output interface displays the driving assistance information.

### BRIEF DESCRIPTION OF THE DRAWINGS

FIG. 1 shows a flowchart of a method for providing driving assistance information according to an embodiment;

FIG. 2 shows an example of a block diagram of a system for providing driving assistance according to an embodiment;

FIG. 3 shows an example of a functional block diagram of the system of FIG. 2;

FIGS. 4A˜4C are schematic diagrams each showing an example of the driving assistance information generated by the system of FIG. 3;

FIGS. 5A˜5H are schematic diagrams each showing another example of the driving assistance information generated by the system of FIG. 3; and

FIG. 6 shows an example of a block diagram of a telematics apparatus according to an embodiment.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Embodiments of a telematics apparatus for providing driving assistance, and a system and a method of the same are disclosed below. In some embodiments, driving assistance information satisfying personal needs can be generated through the analysis of personal driving habit and familiarity with the route, so that the telematics apparatus is more intelligent and applicable to the user. As such, personalized driving assistance information can be provided to satisfy different users, various needs and expectations.

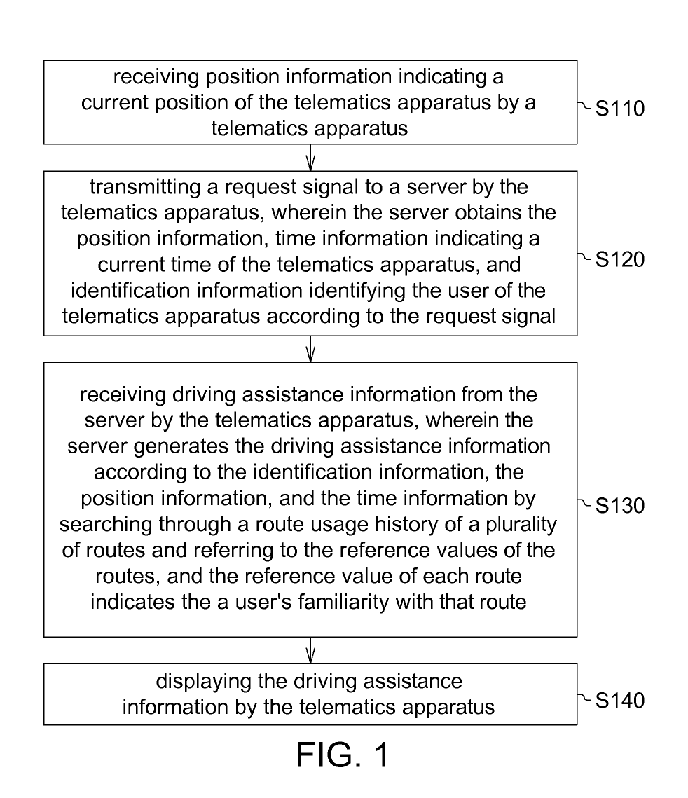

Referring to FIG. 1, a flowchart of a method for providing driving assistance information according to an embodiment is shown. In step S110, the telematics apparatus receives position information indicating a current position of the telematics apparatus. In step S120, the telematics apparatus transmits a request signal to the server. According to the request signal, the server obtains the position information, time information indicating a current time of the telematics apparatus, and identification information identifying a user of the telematics apparatus. In step S130, the telematics apparatus receives driving assistance information from the server. The server generates driving assistance information according to the identification information, the position information, and the time information by searching through a route usage history of a plurality of routes and referring to a plurality of reference values of the routes. The reference value of each route indicates the telematics apparatus user's familiarity with that route. In step S140, the telematics apparatus illustrates the driving assistance information.

The use of position information, time information, and identification information related to the telematics apparatus enables the user to locate possible driving routes towards a destination from the route usage history for the current time and the current position. Moreover, the above search results can be filtered in conjunction with the reference values related to the user's familiarity with the routes, so as to obtain one or more route that is familiar to the user or frequently used by the user. Thus, personalized driving assistance information satisfying different users' various needs and expectations is provided.

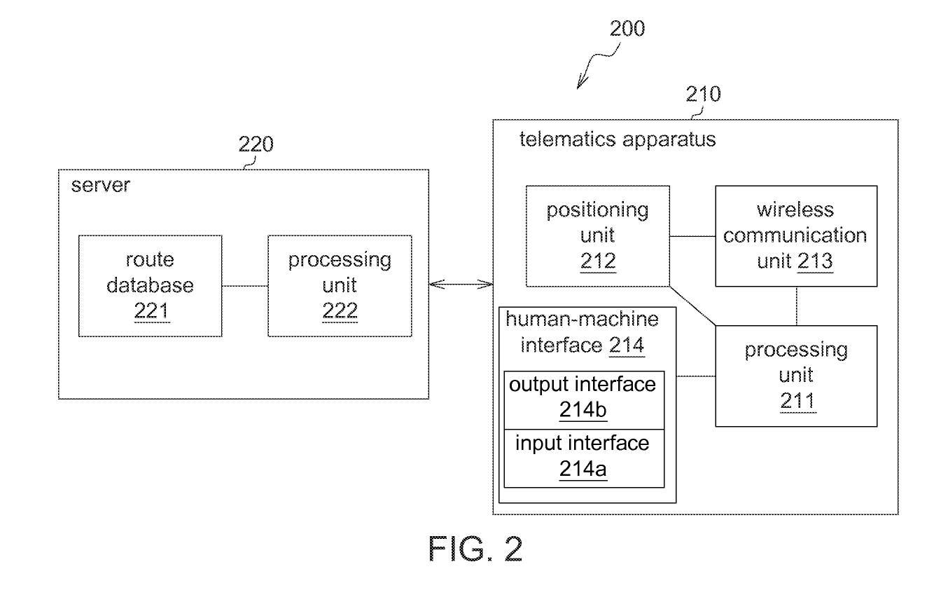

Referring to FIG. 2, an example of a block diagram of a system for providing driving assistance according to an embodiment is shown. The system for providing driving assistance 200 includes a telematics apparatus 210 and a server 220.

The telematics apparatus 210 includes a processing unit 211, a positioning unit 212, a wireless communication unit 213, and a human-machine interface 214. The telematics apparatus 210 is carried by a moving object such as a vehicle or other transportation tool.

The processing unit 211 is operationally connected to the positioning unit 212, the wireless communication unit 213, and the human-machine interface 214 for controlling their operations. The processing unit 211 is realized by such as a micro-processing unit or other processor having computing function.

The positioning unit 212 captures position information indicating a current position of the telematics apparatus. For example, the positioning unit 212 can receive a global navigation satellite system (GNSS) data, and obtains the position information from the GNSS data. For another example, the positioning unit 212 can be based on the global positioning system (GPS), and include sensing elements, antennas, and driving circuits for receiving/transmitting signals.

The wireless communication unit 213 performs communication with the server 220. The wireless communication unit 213 is for example based on wireless fidelity, worldwide interoperability for microwave access (WiMAX), the 3rd generation mobile telecommunications (3G), the 4th generation mobile telecommunications (4G), wireless access in vehicular environments/dedicated short-range communications (WAVE/DSRC), or other related or applicable communication technologies or protocols.

The human-machine interface 214 generates request signals and displays the driving assistance information. The human-machine interface 214 includes an input interface 214a and an output interface 214b. The input interface 214a accepts the user's inquiry, and generates a request signal in response to the inquiry. The input interface 214a includes press-keys, image capturing elements, sound capturing elements, or other interface used for capturing the carrier's environmental parameters such as the parameters related to fuel consumption, speed, tire pressure and braking control. The output interface 214b outputs or displays a variety of information. The output interface 214b includes a display screen, a sound playing element (such as a speaker or a buzzer), or other elements that can be used for displaying information. In some embodiments, the human-machine interface 214 may further include a touch sensitive screen and become an input/output interface.

The server 220 includes a route database 221 and a processing unit 222. The server 220 can be disposed in an indoor environment such as a server room of a telecommunication or Internet dealer/provider. The server 220, being a service center, transmits information to the telematics apparatus 210 for its user such as a driver to use.

The route database 221 stores a route usage history of a plurality of routes. With respect to each route, the route usage history has a reference value indicating a user's familiarity with that route. For example, the higher the reference value of the route is, the more familiar with the route the user of the telematics apparatus 210 is, or the more frequent the route is taken.

In some embodiments, the route usage history is for example a look up table whose historic data is related to previous use of the telematics apparatus 210.

For example, with respect to each route, the route usage history may have several data columns, such as a column for user identification name or identification code, a column for time (start/end time), a column for driving frequency, a column for travel times, a column for route starting point, a column for route ending point (destination), a column for route details (segments forming a route), a column for familiarity with each route (route familiarity), or other data columns related to the route. In this example, the column for the route familiarity contains reference values related to the user's familiarity with the route.

In some embodiments, for the user of the telematics apparatus 210, the reference value of each route is related to at least one of driving frequency, travel times, and time interval between usage of the route.

For example, the reference value can be calculated according to the following formula:

Reference value=f((⁺driving frequency, ⁺travel times); (⁻time interval)),

wherein f(.) denotes the reference value of route familiarity is formed through a weighted combination of several factors. The driving frequency and travel times are positive factors and the time interval is a negative factor. Suppose the driving frequency is high, and/or the travel times is large, and/or the interval between the current use and the previous use of the route is short, the reference value of the route will be large, and a large reference value indicates the user's high familiarity with the route.

In the above formula, the basic unit of time interval is such as the number of days. For example, the time interval can be a number of days between two previous uses of the route, an average of days among several previous uses of the route, or a number of days between the user's most recent use of the route and the current time.

The above formula is exemplified by determining the route familiarity according to three factors (namely, the driving frequency, the travel times, and the time interval), but the disclosure is not limited thereto. In other embodiments, the route familiarity can also be determined according to one or two of the three factors, or according to other factor capable of properly indicating the user's familiarity with the route.

In the telematics apparatus 210, the processing unit 211 controls the wireless communication unit 213 to transmit a request signal to the processing unit 222.

In the server 220, the processing unit 222 receives the request signal, and obtains from the request signal of the telematics apparatus 210 various kinds of information related to the telematics apparatus 210, such as the position information, the time information, the identification information, and/or other information.

The position information indicates a current position of the telematics apparatus 210. The position information is for example a set of GPS coordinates formed by longitude and latitude. The position information is obtained from the GNSS data for example.

The time information indicates a current time of the telematics apparatus. Examples of the time information include the data of time zone, time segment, or time point. The time information is for example received from GNSS data, from a timer of the telematics apparatus 210 or the server 220, or from the Internet.

The identification information identifies the user of the telematics apparatus 210. Examples of the identification information include an international mobile equipment identity number (IMEI) of the wireless communication unit 213 of the telematics apparatus 210, a product serial number defined by the manufacturer, a service account provided by a third party such as a Gmail account or a yahoo account or a user-defined personal account.

In the server 220, the processing unit 222 searches through a route usage history of the route database 221 according to the identification information, the position information, and the time information. The processing unit 222 further refers to a plurality of reference values of the routes according to the search result, and transmits driving assistance information to the telematics apparatus 210.

For example, according to the identification information, the position information, and the time information, the processing unit 222 can search the route usage history for server routes (predicted routes), such as ten predicted routes. The predicted routes can be regarded as the routes ever used by the user around this location and this time, and can be used to determine possible destinations and possible routes ever used by the user around this location and this time. From the predicted routes, the processing unit 222 further selects at least one driving route towards the destination according to the reference values of predicted routes. For example, the processing unit 222 selects several driving routes with higher reference values. Then, the processing unit 222 uses the selected driving routes and their destinations as a driving assistance information and further transmits the driving assistance information to the telematics apparatus 210.

Thus, the route with higher reference value can be selected from the predicted routes, and the selected route, being a route familiar to the user or frequently used by the user, provides the user with suitable driving assistance information. Thus, personalized driving assistance information can be provided to satisfy different users' various needs and expectations.

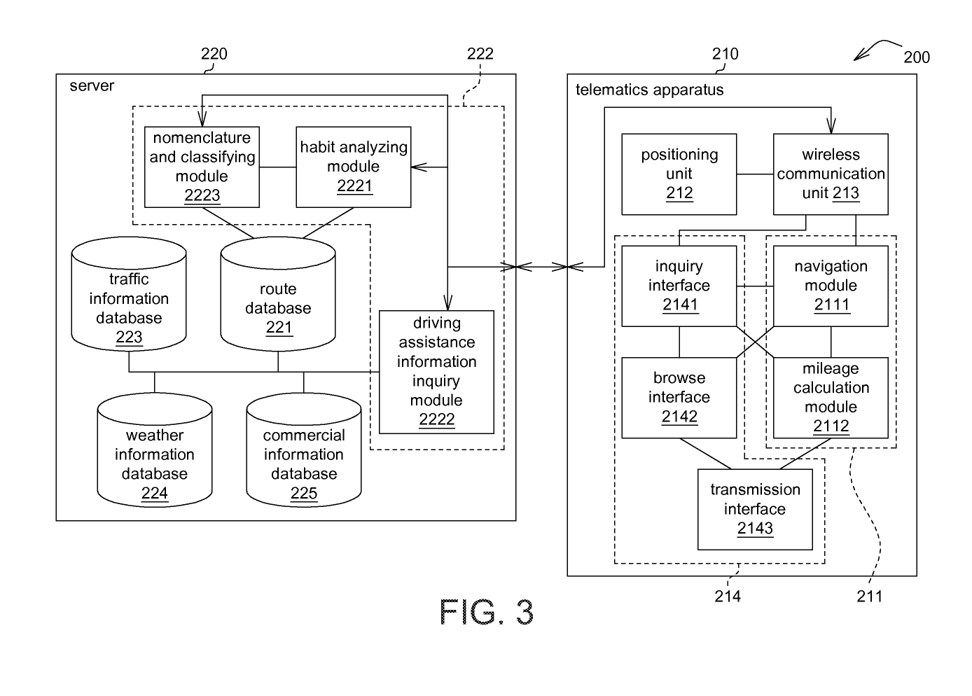

Referring to FIG. 3, an example of a functional block diagram of the system of FIG. 2 is shown.

In the telematics apparatus 210, the human-machine interface 214 includes an inquiry interface 2141, a browse interface 2142, and a transmission interface 2143. The processing unit 211 includes a navigation module 2111 and a mileage calculation module 2112.

In the server 220, the processing unit 222 includes a habit analyzing module 2221, a driving assistance information inquiry module 2222, and a nomenclature and classifying module 2223.

In some embodiments, the server 220 includes a route database 221 in addition to a traffic information database 223, a weather information database 224, and a commercial information database 225. The traffic information database 223 at least includes data columns for street name, identification code, time column, road event, current speed, and/or traffic volume. The weather information database 224 at least includes data columns for time, temperature, weather states that indicating it is sunny, cloudy, rainy, snowing, or fogy, or other weather information. The commercial information database 225 at least includes data columns for store's name, activity time, activity details, and/or store's position.

As such, in the server 220, the processing unit 222 can search through at least one of the traffic information database 223, the weather information database 224, and the commercial information database 225 to generate the driving assistance information.

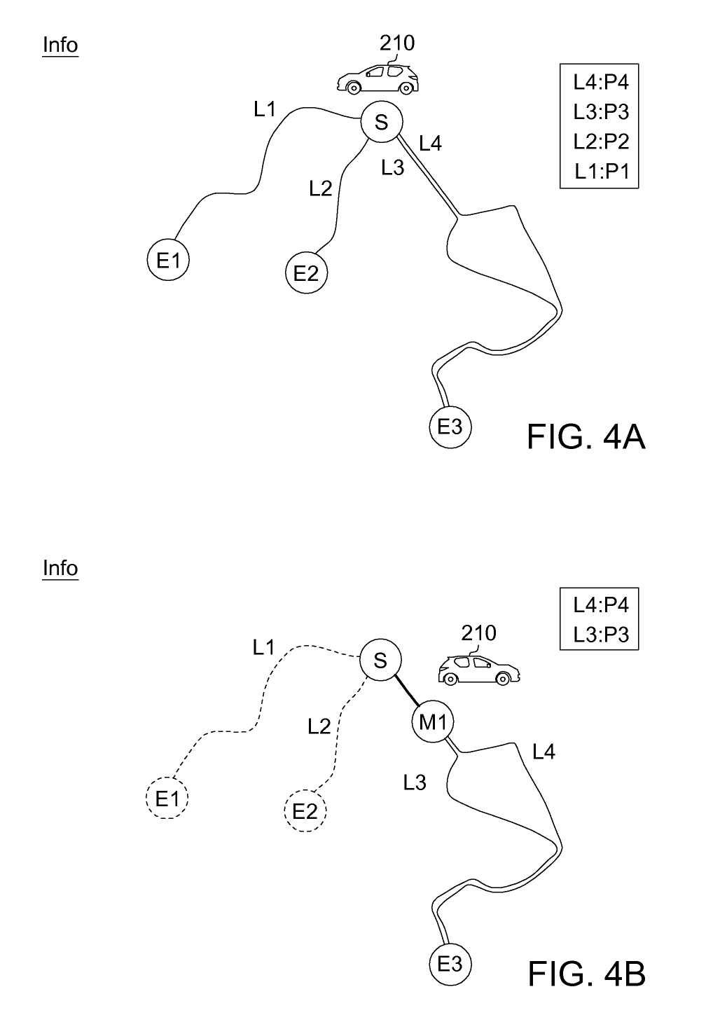

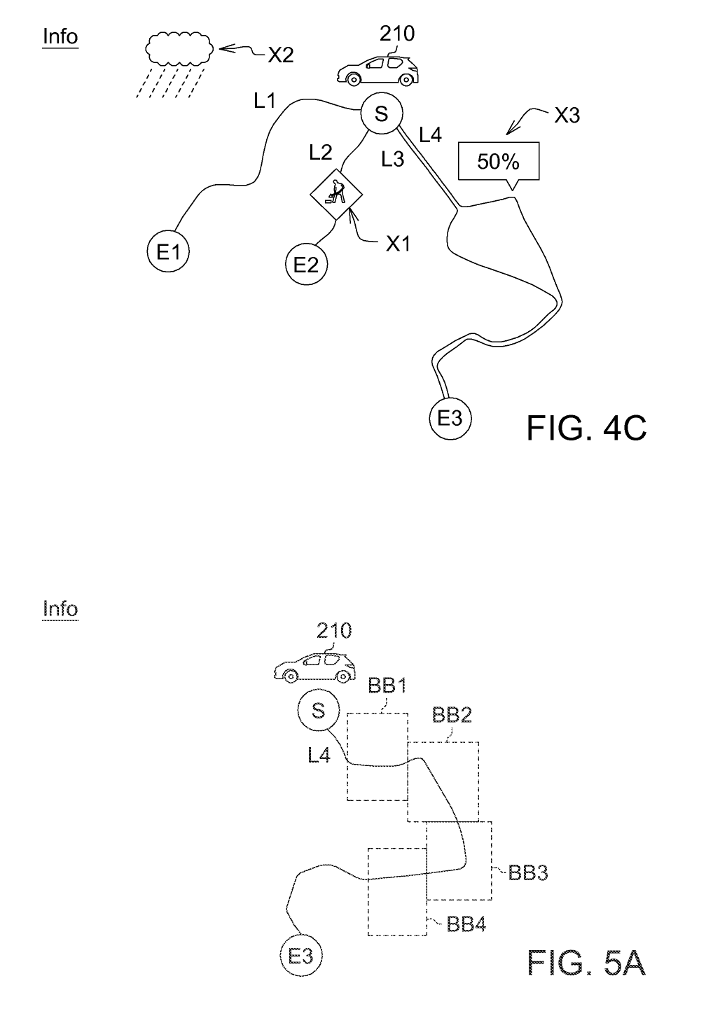

Referring to FIG. 3 and FIGS. 4A˜4C. FIGS. 4A˜4C are schematic diagrams each showing an example of the driving assistance information generated by the system of FIG. 3. The following elaboration is disclosed in conjunction with FIG. 3, FIGS. 4A˜4C.

In the telematics apparatus 210, the positioning unit 212 receives position information (such as GNSS data) related to its current position. In the example of FIG. 4A, the position information indicating the current position of the telematics apparatus 210 is a starting point S.

In the server 220, the habit analyzing module 2221 receives and gathers GNSS data to generate a route composed of consecutive positions and analyze the starting position (starting point), the ending position (ending point, destination), the travel times, the driving frequency of each route, and the familiarity with each route, or other data related to user's habits of using that route. The analyzed data is stored in the route database 221. Thus, the route usage history of several routes can be established.

For example, the habit analyzing module 2221 detects the driving route of the telematics apparatus 210 according to the information of consecutive positions, and compares the driving route with the routes previous used by the user and stored in the route database 221. If the comparison result shows overlapping, then the travel times of the route is progressively increased. The driving frequency can be calculated according to the ratio of the travel times and the unit time. The reference value indicating the user's familiarity with each route can also be calculated by the habit analyzing module 2221.

In the server 220, the nomenclature and classifying module 2223 gives names and classifies the routes, which will be disclosed in certain passages below.

In the telematics apparatus 210, the inquiry interface 2141 receives the user's input, and the wireless communication unit 213 transmits a request signal.

In the server 220, the driving assistance information inquiry module 2222 receives the request signal, and obtains identification information, time information and position information of the telematics apparatus 210 in response to the request signal. The driving assistance information inquiry module 2222 searches the route database 221 for the user's possible destinations and predicted routes towards the possible destinations. The driving assistance information inquiry module 2222 further filters the search results to obtain the users' familiar routes and corresponding destinations to generate the driving assistance information.

In the telematics apparatus 210, the browse interface 2142 displays the driving assistance information. In the examples of FIGS. 4A˜4C, the browse interface 2142 is realized by a display screen, and the driving assistance information Info is a frame displayed on screen. However, the disclosure is not limited thereto, and the driving assistance information can also be displayed in audio form, audio/video form or other forms. Thus, the browse interface 2142 can be realized as other output interface used for illustrating the driving assistance information Info.

In some embodiments, the driving assistance information may include at least one destination and at least one driving route towards the destination.

In the example of FIG. 4A, the driving assistance information Info includes three destinations E1˜E3 and four driving routes L1˜L4. The driving routes L1˜14 can be displayed in conjunction with different texts, drawings or colors, so that the user can clearly identify respective predicted routes and corresponding destinations.

The number of destinations and the number of driving routes towards the destinations contained in the driving assistance information depend on the search result and the filtering result of the driving assistance information inquiry module 2222. In the initial state or under certain circumstances (for example, when the reference value indicating the user's rout familiarity is very small), the destinations and the driving routes towards the destinations may not be located. Under such circumstances, it can be displayed that history data is unavailable.

In some embodiments, the destinations and the driving routes towards the destinations that are both contained in the driving assistance information are ranked.

For example, as indicated in FIG. 4A, the four driving routes L1˜L4 can be ranked according to different recommendation indexes P1˜P4. The recommendation indexes P1˜P4 are for example in an increasing order such as percentages of 2%, 8%, 20%, and 70%. The recommendation indexes can be formed by a weighted combination of various factors such as route driving frequency, speed, fuel consumption, time, traffic, and/or weather, giving the user an overall picture of driving information so that the user can choose the best route to take. For the calculation of the recommendation indexes, some factors are quantified, and all the factors are normalized. For example, the traffic states {smooth, jammed, road work . . . } can be quantified as {100, 0, 0 . . . }.

In some embodiments, the number of destinations and the number of driving routes towards the destinations contained in driving assistance information progressively decrease as the current position of the telematics apparatus 210 varies.

For example, as indicated in FIGS. 4A and 4B, the current position of the telematics apparatus 210 changes to the midway point M1 from the starting point S (the route is illustrated in bold lines). In this case, the driving routes L1˜L2 are very unlikely to be selected by the user. Therefore, in the driving assistance information Info, the driving routes L1˜L2 and their corresponding destinations E1˜E2 will be eliminated, and the driving routes L3˜L4 and their corresponding destination E3 will be left for selection.

In some embodiments, the driving assistance information further includes at least one of traffic information, weather information, and commercial information.

For example, as indicated in FIG. 4C, the driving assistance information Info further contains a traffic information X1, a weather information X2, and a commercial information X3. The traffic information X1 indicates the road work on the driving route L2, the weather information X2 indicates the raining weather, and the commercial information X3 indicates promotion activities such as discounts provided by a store located on the driving route L4.

Thus, at least one of the traffic information, the weather information, and the commercial information can be included in the driving assistance information and transmitted to the telematics apparatus 210, enabling the telematics apparatus 210 to display the driving assistance information with sounds, texts or pictures. Thus, the information is more enriched and made more convenient to use.

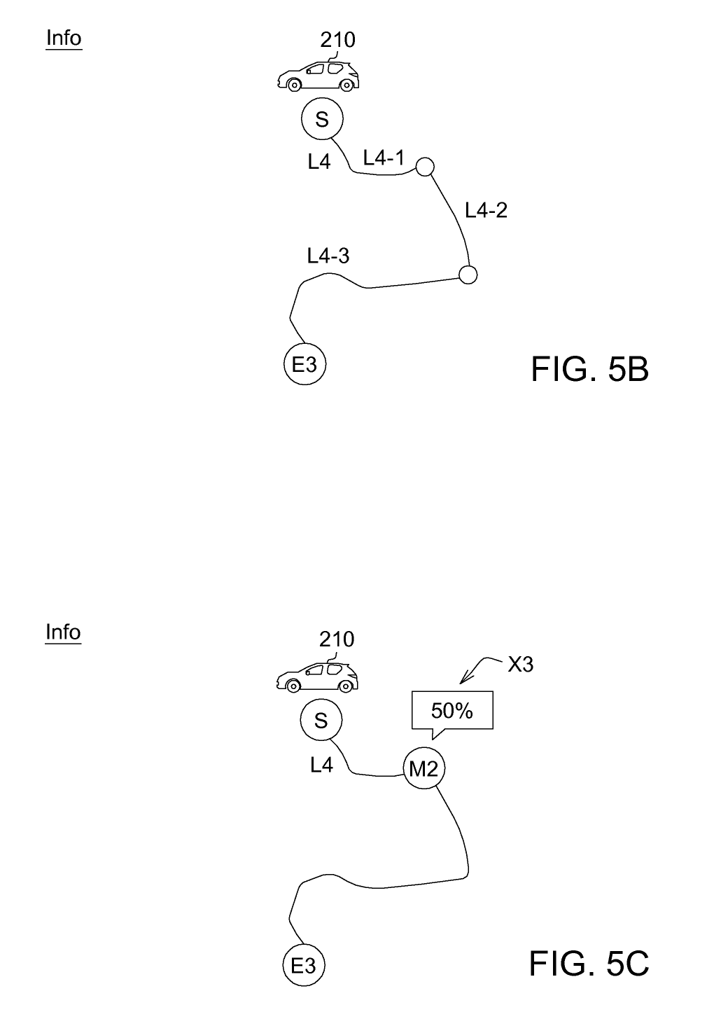

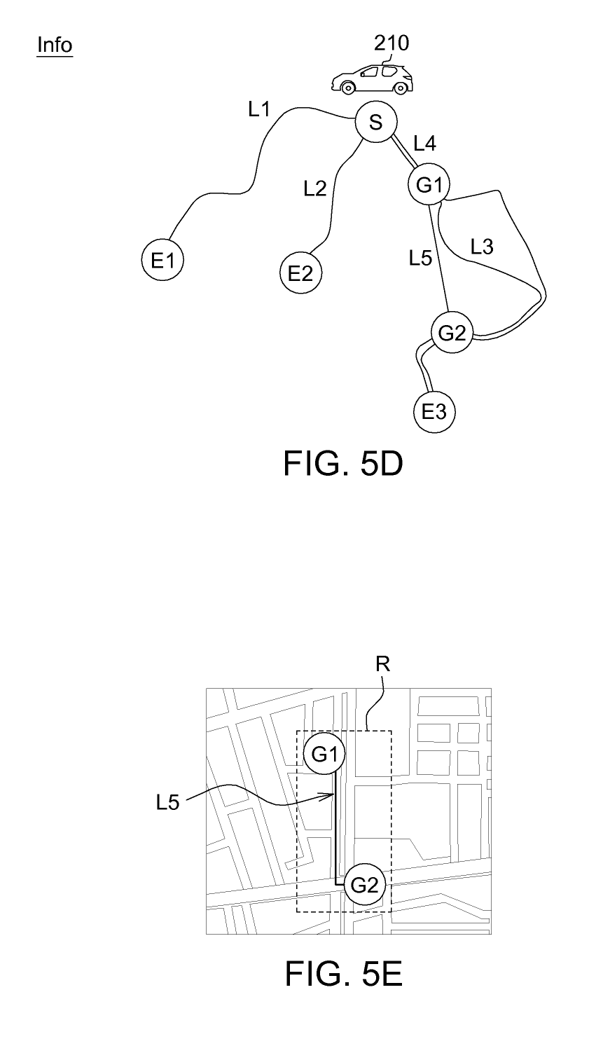

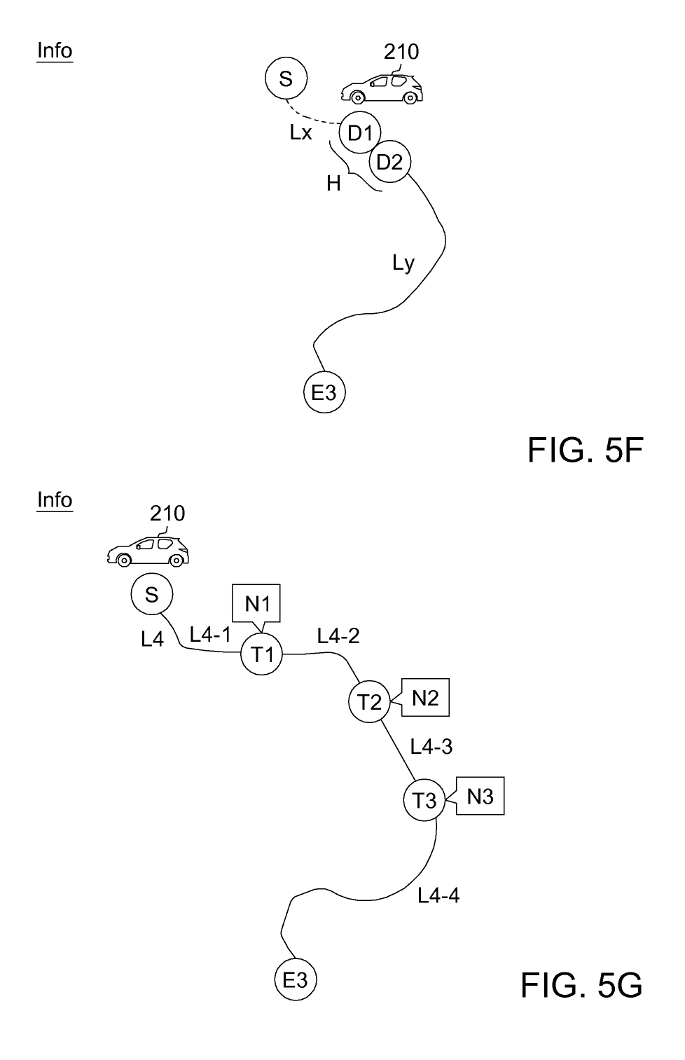

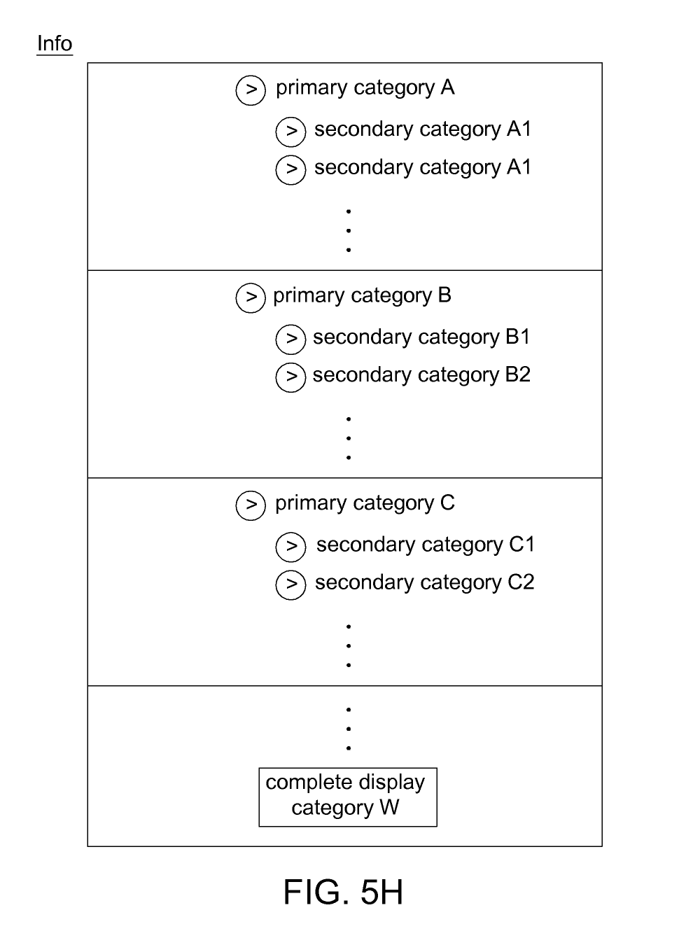

FIGS. 5A˜5H are schematic diagrams each showing another example of the driving assistance information generated by the system of FIG. 3.

In some embodiments, the driving assistance information further contains at least one of the traffic information, the weather information, and the shopping mall information within a predicted range that the telematics apparatus is going to enter from its current position.

For example, as indicated in FIG. 5A, there are several bounding boxes BB1˜BB4 located along the driving route L4. Each of the bounding boxes BB1˜BB4 indicates a predicted range. The server 220 determines whether the telematics apparatus 210 enters one of the predicted ranges (such as the bounding box BB1 for example) according to the current position of the telematics apparatus 210. If yes, then the server 220 obtains the traffic information and the commercial information within the bounding box BB1 from the traffic information database and the commercial information database and obtains the current weather information from the weather information database obtains, and then adds these items of information to the driving assistance information Info. Afterwards, it is determined whether the telematics apparatus 210 enters the bounding box BB2, and adds the traffic, the commercial or the weather information within the bounding box BB2 to the driving assistance information Info.

Thus, the driving assistance information can be presented in the form of a bounding box during the driving process. Compared with the way of providing too much and too complicated information at a time, the way of providing one personalized driving assistance information at a time is more convenient to the user.

In the above exemplifications, the bounding boxes are sequentially illustrated one at a time, but the disclosure is not limited thereto, and several (such as two or more than two) bounding boxes can be illustrated at the same time. For example, whether the telematics apparatus 210 enters the bounding box BB1 is determined. If yes, then the driving assistance information contained in four bounding boxes BB1˜BB4 are displayed at the same time.

In some embodiments, each driving route is composed of several segments, and the driving assistance information contains turn-by-turn navigation information of at least a part of the segments.

As indicated in FIG. 5B, each driving route is composed of several segments such as segments L4-1˜L4-3 of the driving route L4. In the telematics apparatus 210, the navigation module 2111 performs segment navigation on each of the segments L4-1˜L4-3 of the driving route L4. In the route usage history, each of the segments L4-1˜L4-3 has a corresponding reference value indicating the user's familiarity with the segment, and the navigation module 2111 provides different levels of driving assistance information according to the reference values of the segment L4-1˜L4-3.

For example, if the reference value of the segment L4-2 is larger than a threshold value, this indicates the telematics apparatus 210 has high familiarity with the segment L4-2. In this case, when travelling through the segment L4-2, the telematics apparatus 210 does not provide the turn-by-turn navigation information to avoid causing auditory or visual nuisance to the user.

For another example, if the reference value of the segment L4-1 is larger than a threshold value K1, then only navigation information in the form of frame and text is provided. If the reference value of the segment L4-2 ranges between the threshold values K1 and K2 (K2<K1), then the navigation information in the form of buzzer is provided in addition to the navigation information in the form of frame and text. If the reference value of the segment L4-3 is smaller than the threshold value K2, then complete navigation information in the form of frame, text, audio or other form is provided.

In some embodiments, when a store's activity time is close to or not earlier than a predicted arrival time, the driving assistance information contains the commercial information, wherein the predicted arrival time indicates the estimated time that the telematics apparatus 210 will arrive at the store's position from its current position.

For example, as indicated in FIG. 5C, the store's position is located in the midway point M2 of the driving route L4. In the telematics apparatus 210, the mileage calculation module 2112 estimates the time to arrive at the midway point M2 according to the driving assistance information Info and the vehicular environment parameter (such as speed, fuel consumption) captured by the transmission interface 2143. The predicted arrival time can be obtained from a weighted combination of factors such as the historic average time to arrive at the said point, the historic average speed, the current speed and/or the current available fuel. To calculate the predicted arrival time, some of the factors can be quantified, and all factors are normalized. For example, the descriptions of available fuel: {full tank, half tank, little . . . } can be quantified as: {100, 50, 0 . . . }.

If it is determined that the store's activity time can be met, then the mileage calculation module 2112 controls the browse interface 2142 to display the commercial information X3. If the store's activity time cannot be met, then the commercial information will not be displayed. Therefore, in the commercial information, the information of the activities whose schedule can be met is provided, and of the information of the activities that the user cannot attend in time is filtered off, so that the apparatus is more convenient to use.

In some embodiments, with respect to route usage history, each route has another reference value indicating another telematics apparatus user's familiarity with that route. Under such circumstance, in the server 220, the processing unit 222 refers to another reference value of the route to generate the driving assistance information.

For example, as indicated in FIG. 5D, apart from the driving routes L1˜14 of the user of the telematics apparatus 210, the driving assistance information Info further contains another driving route L5 which is provided by a user of another telematics apparatus. The driving route L5 is exemplified as being overlapped with at least one of the driving routes L1˜L4. The overlap is for example from the starting point S to the bifurcation point G1, and from the bifurcation point G2 to the ending point. In other words, the route from the bifurcation point G1 to the bifurcation point G2 can be regarded as a shortcut.

Thus, when someone knows the shortest or most convenient route to a destination, such route can be shared and used for other users' reference to increase convenience.

In some embodiments, for the user of another telematics apparatus, the another reference value of each route is related to driving frequency or coverage rate of all roads covered within a coverage range.

For example, as indicated in FIG. 5E, the bifurcation point G1 and the bifurcation point G2 are within a coverage range R of the driving route L5. The coverage range R covers several roads including the driving route L5. The driving frequencies of the driving route L5 and other roads can be calculated from their travel times. The coverage rate within the coverage range R is defined as P/O, wherein O denotes the total number of roads within the coverage range R, and P denotes the number of roads with a driving frequency larger than the threshold value within the coverage range R. The larger the travel times of the route and the coverage rate, the larger the other reference value indicating the user's high familiarity with the route.

In some embodiments, the driving assistance information further contains a hot spot when the distance between two parking points of the telematics apparatus 210 or another telematics apparatus is smaller than a predetermined distance and the stay time is longer than a predetermined time.

For example, as indicated in FIG. 5F, the telematics apparatus 210 generates two parking points D1 and D2. The server 220 determines whether the distance between the two parking points D1 and D2 (such as the coordinate distance between two consecutive GNSS data) is smaller than a predetermined distance to locate parking points whose GNSS positions are substantially the same or slightly different from each other within a period of time. Next, the server 220 determines whether the stay time of the telematics apparatus 210 from the parking point D1 to the parking point D2 is larger than a predetermined value T. If yes, then the times of staying at the parking point D1 or D2 is increased. If the times of staying at certain point (denoted as P) and/or the stay frequency (=P/T) reaches a threshold value, this indicates that that parking point means something to the user. Meanwhile, the parking point, which can be designated in different color and with texts or pictures, denotes a hot spot H.

For another example, as indicated in FIG. 5F, two parking points D1 and D2 can denote the ending point and the starting point respectively. In other words, the parking point D1 is the ending point of a previous segment Lx and the parking point D2 is the starting point of a subsequent segment Ly. Such situation may occur when the GNSS data is interrupted. That is, when the telematics apparatus 210 stops transmitting the position information due to shut-down or power-off, the server 220 determines the last position as the ending point of the route. Likewise, a hot spot H can be generated accordingly when the distance between the ending point of one segment and the starting point of another segment is smaller than a predetermined distance, and the stay time is larger than the predetermined time.

For another example, the hot spot H can also be determined with reference to collective information. In other words, the server 220 refers to the information left by another telematics apparatus, and makes determination according to the distance information and the time information disclosed above to generate the hot spot H.

In some embodiments, the driving assistance information Info further contains respective segments of each driving route. Each segment is named or classified at least according to districts, public facilities, or shops.

For example, as indicated in FIG. 5G, in the server 220, each driving route is composed of several routes or segments, such as the segments L4-1˜L4-4 of the driving route L4. The segments L4-1˜L4-4 are differentiated by the starting point S, several turning points T1˜T3, and the ending point E3. Segment names such as names N1˜N3 can be marked on turning points T1˜T3. A segment can be named after districts, public facilities, or shops. For example, a segment can be named after the name of a county, a city, a township, a village, a district, a neighborhood, a bus stop, a metro station, a high-speed railway station, a highway interchange, a company, a landmark, a scenery spot, a convenience store, a street or a department store, a common name or so on.

The segments can be classified according to the address or the locality. For example, the complete address of a segment includes a highest level such as county and city, a second highest level such as district and township, and a lowest level such as suburb, bus stop or other names.

In some embodiments, the driving assistance information Info can be displayed in a zoomable map. Meanwhile, the name of each segment may vary with the zoom level of the map.

For example, as indicated in FIG. 5G, the driving assistance information Info is displayed in a zoomable map in the form of multi-level categorization. The zoom levels include for example a first zoom level, a second zoom level, a third zoom level which are arranged in a descending order.

In the first zoom level, the segments N1˜N3 are such as counties or cities at the highest level with a largest range of coverage. For example, N1 denotes Taipei, N2 denotes Taoyuan, N3 denotes Hsinchu.

When the zoom level is switched to the second zoom level, the names of the segments N1˜N3 vary accordingly. In the second zoom level, the segments N1˜N3 are such as districts or townships at the second highest level with a second largest range of coverage. For example, N1 denotes Yonghe; N2 denotes Yangmei; N3 denotes Chupei.

When the zoom level is switched to the third zoom level, the names of the segments N1˜N3 vary accordingly. In the third zoom level, the segments N1˜N3 are such as a neighborhood, a bus stop, a metro station, a high-speed railway station, a highway interchange, a company, a landmark, a scenery spot, a convenience store of the lowest level with a smallest range of coverage. For example N1 denotes the Yonghe Primary School; N2 denotes the Yangmei Station; N3 denotes the Chupei High speed Railway Station.

In some embodiments, the driving assistance information Info can be displayed in a hierarchical menu. Meanwhile, the name of each segment varies as the hierarchical menu is expanded.

As indicated in FIG. 5H, the driving assistance information Info is displayed in a hierarchical menu in the form of multi-level categorization. The menu includes various categories such as a first category, a second category, and a third category arranged in a descending order.

In the first category, the segments illustrated as “primary category A”, “primary category B”, and “primary category C” are counties or cities with a largest range of coverage. For example, the primary category A denotes Taipei; the primary category B denotes Taoyuan; the primary category C denotes Hsinchu.

As the hierarchical menu is expanded, the second category will be displayed. Meanwhile, in the second category, the segment names illustrated as “the secondary category A1”, “the secondary category B1”, “and the secondary category C1” are districts or townships with a second largest range of coverage. For example, the secondary category A1 denotes Yonghe; the secondary category B1 denotes Yangmei; the secondary category C1 denotes Chupei.

As the hierarchical menu is expanded, the third category will be displayed. Meanwhile, in the third category, the segment name illustrated as “the complete display category W” is such as the name of a neighborhood, a bus stop, a metro station, a high-speed railway station, a highway interchange, a company, a landmark, a scenery spot, a convenience store, a street or a department store of the lowest level with a smallest range of coverage. For example, the complete display category W denotes the Yonghe Primary bus stop, the Yangmei Station, the Chupei High speed Railway Station.

The above disclosure is exemplified by the illustration of the names of three segments, but the disclosure is not limited to such exemplification. When a fourth segment exists, its name can be illustrated with an extra primary category. Or, if the fourth segment belongs to primary category A, B or C, then the fourth segment can be illustrated as “the secondary category A2”, “the secondary category B2”, or “the secondary category C2”.

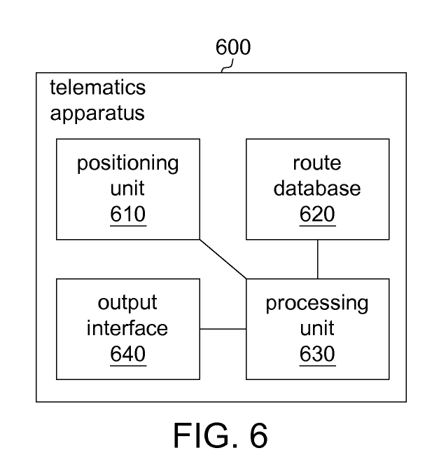

Referring to FIG. 6, an example of a block diagram of a telematics apparatus according to an embodiment is shown. The telematics apparatus 600 can be implemented by integrating at least partial elements of the server 220 into the telematics apparatus 200, and through suitable circuit design, an electronic device which can be independently operated to provide driving assistance information will be implemented.

To put it in greater details, the telematics apparatus 600 includes a positioning unit 610, a route database 620, a processing unit 630, and an output interface 640. The positioning unit 610 captures position information indicating a current position of the telematics apparatus 600. The route database 620 stores a route usage history of a plurality of routes. For each route, the route usage history has a reference value indicating a user's familiarity with the route. The processing unit 630 obtains the position information, identification information, and time information. The identification information identifies a user of the telematics apparatus 600. The time information indicates a current time of the telematics apparatus 600. The processing unit 630 further generates driving assistance information by searching through the route usage history according to the identification information, the position information, and time information and referring to a plurality of reference values of the routes according to the search result. The driving assistance information contains at least one destination and at least one driving route towards the destination. The output interface 640 illustrates the driving assistance information. The operations of the telematics apparatus 600 are similar to that of the server 220 and the telematics apparatus 200, and are not repeated here.

According to the telematics apparatus for providing driving assistance, and the system and the method of the same disclosed in the above embodiments of the disclosure, driving assistance information conformed to individual needs is generated through the analysis of personal driving habit and familiarity with the route, so that the telematics apparatus is more intelligent and applicable to the user. Thus, personalized driving assistance information is provided to satisfy different users' various needs and expectations.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A telematics apparatus, comprising:
a positioning unit configured to capture position information indicating a current position of the telematics apparatus;
a database configured to store a route usage history of a plurality of routes, wherein, for each route, the route usage history has a reference value indicating a user's familiarity with that route;
a processing unit configured to obtain the position information, identification information, and time information, wherein the identification information identifies a user of the telematics apparatus, the time information indicates a current time of the telematics apparatus, and the processing unit further generates driving assistance information by searching through the route usage history according to the identification information, the position information, and the time information and referring to the reference values of the routes according to the search result; and
an output interface configured to display the driving assistance information.

2. The telematics apparatus according to claim 1, wherein, for the user of the telematics apparatus, the reference value of each route is related to at least one of a driving frequency, a travel times, and an time interval between usage of the route.

3. The telematics apparatus according to claim 1, wherein the driving assistance information contains at least one destination and at least one driving route towards the destination.

4. The telematics apparatus according to claim 3, wherein the destinations and the driving routes towards the destinations contained in the driving assistance information are ranked.

5. The telematics apparatus according to claim 3, wherein the number of destinations and the number of driving routes towards the destinations contained in the driving assistance information decrease as the current position of the telematics apparatus varies.

6. The telematics apparatus according to claim 3, wherein the at least one driving route towards the destination is selected from a plurality of predicted routes according to the reference values of the predicted routes, and the predicted routes are located from the route usage history by the processing unit according to the identification information, the position information, and the time information.

7. The telematics apparatus according to claim 3, wherein each driving route is composed of several segments, and the driving assistance information contains turn-by-turn navigation information of at least a part of the segments.

8. The telematics apparatus according to claim 3, wherein each driving route is composed of several segments, and each segment is named or categorized at least according to districts, public facilities, or shops.

9. The telematics apparatus according to claim 3, wherein the driving assistance information is displayed in a zoomable map, and the name of each segment varies with the zoom level of the map.

10. The telematics apparatus according to claim 3, wherein, the driving assistance information is displayed in a hierarchical menu, and the name of each segment varies as the hierarchical menu is expanded.

11. The telematics apparatus according to claim 1, wherein the telematics apparatus further comprises at least one of the following elements:
a traffic information database configured to store traffic information;
a weather information database configured to store weather information; and
a commercial information database configured to store shopping mall information;
wherein, the processing unit further searches through at least one of the traffic information database, the weather information database, and the commercial information database to generate the driving assistance information.

12. The telematics apparatus according to claim 1, wherein the driving assistance information further contains at least one of traffic information, weather information and commercial information within a predicted range that the telematics apparatus is going to enter from its current position.

13. The telematics apparatus according to claim 12, wherein when a store's activity time of the commercial information is close to or not earlier than a predicted arrival time, the driving assistance information contains the commercial information, and the predicted arrival time indicates an estimated time for the telematics apparatus will arrive at a shopping mall position of the store's information from its current position.

14. The telematics apparatus according to claim 1, wherein with respect to each route, the route usage history has another reference value indicating another telematics apparatus user's familiarity with that route, wherein the processing unit further refers to another reference value of the route to generate the driving assistance information.

15. The telematics apparatus according to claim 14, wherein, for the user of another telematics apparatus, the another reference value of each route is related to driving frequency or coverage rate of all roads covered within a coverage range.

16. The telematics apparatus according to claim 1, wherein the driving assistance information further contains a hot spot when the distance between two parking points of the telematics apparatus or another telematics apparatus is smaller than a predetermined distance and the stay time is longer than a predetermined time.

17. A method for providing driving assistance information, comprising:
receiving position information indicating a current position of the telematics apparatus by a telematics apparatus;
transmitting a request signal to a server by the telematics apparatus, wherein the server obtains the position information, time information indicating a current time of the telematics apparatus, and identification information identifying a user of the telematics apparatus according to the request signal;
receiving driving assistance information from the server by the telematics apparatus, wherein the server generates the driving assistance information according to the identification information, the position information, and the time information by searching through a route usage history of a plurality of routes and referring to reference values of the routes, and the reference value of each route indicates the telematics apparatus user's familiarity with that route; and
displaying the driving assistance information by the telematics apparatus.

18. The method according to claim 17, wherein, for the user of the telematics apparatus, the reference value of each route is related to at least one of a driving frequency, a travel times and an time interval between usage of the route.

19. The method according to claim 17, wherein the driving assistance information contains at least one destination and at least one driving route towards the destination.

20. The method according to claim 19, wherein the server searches through the route usage history according to the identification information, the position information, and the time information to locate a plurality of predicted routes, and selects the at least one driving route towards the destination from the predicted routes according to the reference values of the predicted routes.

21. A system for providing driving assistance, comprising:
a telematics apparatus configured to transmit a request signal: and a server, comprising:
a database configured to store a route usage history of a plurality of routes, wherein, for each route, the route usage history has a reference value indicating a user's familiarity with that route; and
a processing unit configured to obtain identification information identifying a user of the telematics apparatus, position information indicating a current position of the telematics apparatus, and time information indicating a current time of the telematics apparatus according to the request signal, wherein the processing unit generates driving assistance information by searching through the route usage history according to the identification information, the position information, and the time information and referring to the reference values of the routes according to the search result, and further transmits the driving assistance information to the telematics apparatus.

22. The system for providing driving assistance according to claim 21, wherein the server further comprises at least one of the following elements:
a traffic information database configured to store traffic information;
a weather information database configured to store weather information; and
a commercial information database configured to store shopping mall information;
wherein, the processing unit further searches through at least one of the traffic information database, the weather information database, the commercial information database to generate the driving assistance information.

23. The system for providing driving assistance according to claim 21, wherein the telematics apparatus comprises:
a positioning unit configured to capture the position information;
a wireless communication unit configured to transmit the request signal;
an output interface configured to display the driving assistance information; and
another processing unit operationally connected to the positioning unit, the wireless communication unit, and the output interface.
